(19) United States
(12) Patent Application Publication
(10) Pub. No.: US 2007/0253433 A1
(43) Pub. Date: Nov. 1, 2007

(54) Network apparatus and network address translation configuration method

(75) Inventors: Cheng-Yi Hsieh, Shenzhen (CN); Chi-Chao Lai, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/309,876

(22) Filed: Oct. 17, 2006

(30) Foreign Application Priority Data
Apr. 28, 2006 (TW) 95115372

(51) Int. Cl. H04L 12/28

(52) U.S. Cl. 370/400

(57) ABSTRACT

A network apparatus (10) for network address translation (NAT) configuration includes a web server (200), a wide area network (WAN) setting module (300), a dynamic host configuration protocol (DHCP) setting module (400), and an NAT setting module (500). The web server receives a WAN protocol message and an easy-mode enable message. The WAN setting module sets the WAN protocol message. The DHCP setting module sets DHCP predefined information according to the easy-mode enable message. The NAT setting module sets NAT predefined information according to the easy-mode enable message. The setting results of the WAN setting module, the DHCP setting module, and the NAT setting module are executed to complete the NAT configuration of the network apparatus. An NAT configuration method thereof is also provided.

### FIELD OF THE INVENTION

The invention relates to network communications, and particularly to a network apparatus and a network address translation (NAT) configuration method.

### DESCRIPTION OF THE RELATED ART

A network address translation (NAT) function can assign Internet protocol (IP) addresses, namely internal IP addresses, to each computer device according to different requirements within an intranet network. In the intranet network, computers communicate with each other via the internal IP addresses. When one of the computers needs to communicate with the Internet, an apparatus with the NAT function translates the internal IP address of the computer to an external IP address (namely an applied IP address) and consequently, the computer can have Internet access.

In a conventional NAT integrated access device (IAD), in order to configure an NAT, users need to log in on a user interface (UI) provided by the NAT IAD, and manually set a wide area network (WAN) protocol, a dynamic host configuration protocol (DHCP) server, an NAT and so on. However, manual setting is difficult for many users to perform even when referring to setting instructions of a user manual, and only skilled users are able to complete the task successfully without the aid of the user manual.

Overall, it is very difficult for common users to configure the NAT. Moreover, some users do not even know how to set up the DHCP server and the NAT at all.

### SUMMARY OF THE INVENTION

An exemplary embodiment of the present invention provides a network apparatus for automatic network address translation (NAT) configuration. The network apparatus includes a web server, a wide area network (WAN) setting module, a dynamic host configuration protocol setting module, and an NAT setting module. The web server receives a WAN protocol message and an easy-mode enable message. The WAN setting module sets the WAN protocol message. The DHCP setting module sets DHCP predefined information according to the easy-mode enable message. The NAT setting module sets NAT predefined information according to the easy-mode enable message. The setting results of the WAN setting module, the DHCP setting module, and the NAT setting module are executed to complete the NAT configuration of the network apparatus.

Another exemplary embodiment of the present invention provides an NAT configuration method. The method includes: receiving a WAN protocol message and an easy-mode enable message; setting the WAN protocol message; setting DHCP predefined information according to the easy-mode enable message; setting NAT predefined information according to the easy-mode enable message; and executing all settings to complete the NAT configuration.

Other advantages and novel features will become more apparent from the following detailed description when taken in conjunction with the accompanying drawings, in which:

### BRIEF DESCRIPTION OF THE DRAWINGS

FIG. 1 is a schematic block diagram of functional modules of a network apparatus of an exemplary embodiment of the present invention;

FIG. 2 is a diagram illustrating a forwarding rule table of another exemplary embodiment of the present invention;

FIG. 3 is a flowchart of a network address translation (NAT) configuration method of a further exemplary embodiment of the present invention; and

FIG. 4 is a detailed flowchart of the NAT configuration method of FIG. 3.

### DETAILED DESCRIPTION OF THE INVENTION

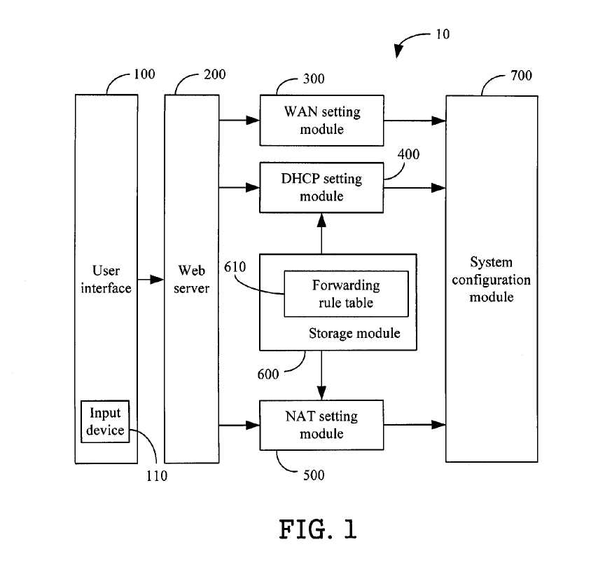

FIG. 1 is a schematic block diagram of functional modules of a network apparatus 10 of an exemplary embodiment of the present invention. In the exemplary embodiment, the network apparatus 10 may be an integrated access device (IAD), a router, a modem, or other network apparatus with an NAT function. The network apparatus 10 is automatic and does not require manually setting a dynamic host configuration protocol (DHCP) server and a network address translation (NAT), and provides users an easy and fast way to configure the NAT, thereby easily acquiring a network service.

The network apparatus 10 includes a user interface 100, a web server 200, a wide area network (WAN) setting module 300, a DHCP setting module 400, an NAT setting module 500, a storage module 600, and a system configuration module 700.

The storage module 600 includes DHCP predefined information and NAT predefined information. In the exemplary embodiment, the DHCP predefined information includes local area network (LAN) Internet protocol (IP) address information, DHCP server enable information, DHCP server pool start/end address information, and DHCP lease time information. Accordingly, the DHCP setting module 400 can set an LAN IP address, enable a DHCP server, set DHCP server pool start/end addresses, and set a DHCP lease time according to the DHCP predefined information. In this embodiment, the DHCP server pool includes only one IP address. The IP address is assigned to a personal computer first connected to the network apparatus 10 at an LAN side of the network apparatus 10.

The NAT predefined information includes NAT enable information and a forwarding rule table 610. Accordingly, the NAT setting module 500 can enable an NAT and set the forwarding rule table 610 according to the NAT predefined information. In this embodiment, all user datagram protocol (UDP)/transport control protocol (TCP) packets can be forwarded to the one IP address in the DHCP server pool aside from packets belonging to the network apparatus 10 according to the forwarding rule table 610 of the storage module 600.

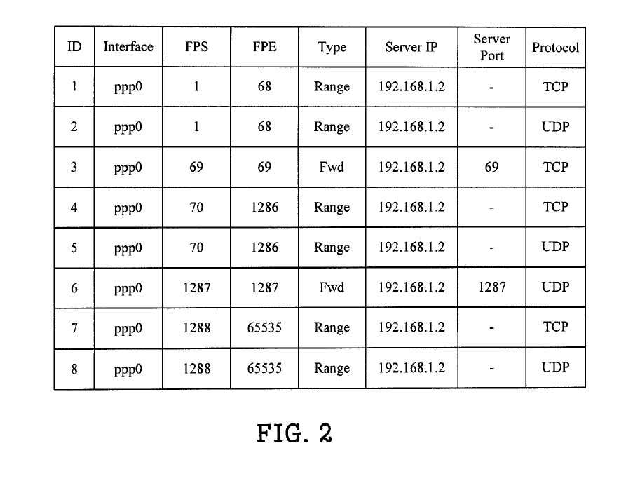

FIG. 2 is a diagram illustrating the forwarding rule table 610 of an exemplary embodiment of the present invention. The forwarding rule table 610 includes an identifier (ID) field, an interface field, a forward port start (FPS) field, a forward port end (FPE) filed, a type field, a server IP field, a server port field, and a protocol field. By setting the fields of the forwarding rule table 610, the network apparatus 10 can forward all UDP/TCP packets to the one IP address in the DHCP server pool aside from packets belonging to the network apparatus 10.

For example, if the LAN IP address is 192.168.1.1, the DHCP server start and end addresses are both 192.168.1.2 (namely the one IP address in the DHCP server pool), and the DHCP lease time is 86400 seconds, the network apparatus 10 can forward all UDP/TCP packets to the IP address 192.168.1.2 in the DHCP server pool aside from packets with UDP port 69 or TCP port 1287 from an interface ppp0 (point-to-point protocol 0), according to the settings of the fields of the forwarding rule table 610 of FIG. 2. The packets with UDP port 69 or TCP port 1287 from the interface ppp0 belongs to the network apparatus 10.

Referring again to FIG. 1, the user interface 100 receives a WAN protocol message and an easy-mode enable message, and transmits the WAN protocol message and the easy-mode enable message to the web server 200. In the exemplary embodiment, the WAN protocol message includes point to point over Ethernet (PPPoE) information, a username, and a password.

In other embodiments, the WAN protocol message may include other protocol information, such as DHCP, static IP addresses.

In the exemplary embodiment, the user interface 100 includes an input device 110, for receiving the easy-mode enable message. In this embodiment, when a user inputs the WAN protocol message to the user interface 100 and presses the input device 110 such as a button, the web server 200 receives the WAN protocol message and the easy-mode enable message from the user interface 100. Then, the web server 200 transmits the WAN protocol message to the WAN setting module 300, and transmits the easy-mode enable message to the DHCP setting module 400 and the NAT setting module 500.

The WAN setting module 300 sets the WAN protocol message. In the exemplary embodiment, the WAN setting module 300 receives the WAN protocol message from the web server 200, and sets the WAN protocol message such as the PPPoE, the username, and the password.

The DHCP setting module 400 sets the DHCP predefined information according to the easy-mode enable message. In the exemplary embodiment, the DHCP setting module 400 receives the easy-mode enable message from the web server 200, reads and sets the DHCP predefined information according to the easy-mode enable message, including steps of setting the LAN IP address, enabling the DHCP server, and setting the DHCP server start/end addresses, and setting the DHCP lease time.

The NAT setting module 500 sets the NAT predefined information according to the easy-mode enable message. In the exemplary embodiment, the NAT setting module 500 receives the easy-mode enable message from the web server 200, reads and sets the NAT predefined information according to the easy-mode enable message, including steps of enabling the NAT and setting the forwarding rule table 610. Finally, the setting results of the WAN setting module 300, the DHCP setting module 400, and the NAT setting module 500 are executed to complete the NAT configuration of the network apparatus 10.

The system configuration module 700 stores and executes the setting results of the WAN setting module 300, the DHCP setting module 400, and the NAT setting module 500 to complete the NAT configuration. In the exemplary embodiment, after the settings of the WAN setting module 300, the DHCP setting module 400, and the NAT setting module 500 are completed, the network apparatus 10 will be rebooted to execute the setting results, thereby completing the NAT configuration of the network apparatus 10.

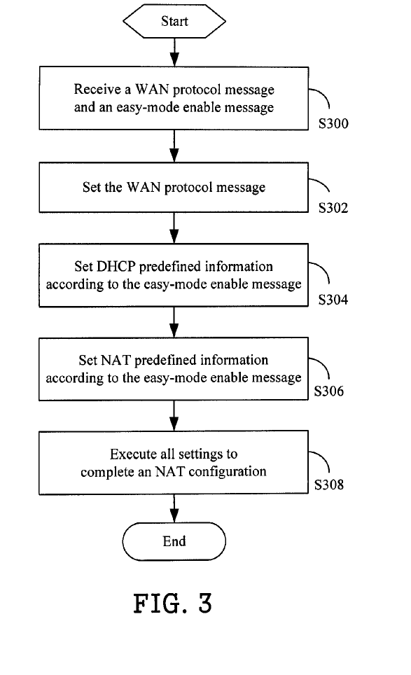

FIG. 3 is a flowchart of an NAT configuration method of an exemplary embodiment of the present invention.

In step S300, the web server 200 receives a WAN protocol message and an easy-mode enable message via the user interface 100.

In step S302, the WAN setting module 300 sets the WAN protocol message, including information such as a PPPoE, a username, and a password.

In step S304, the DHCP setting module 400 sets DHCP predefined information according to the easy-mode enable message.

In step S306, the NAT setting module 500 sets NAT predefined information according to the easy-mode enable message.

In step S308, the system configuration module 700 executes all settings to complete the NAT configuration.

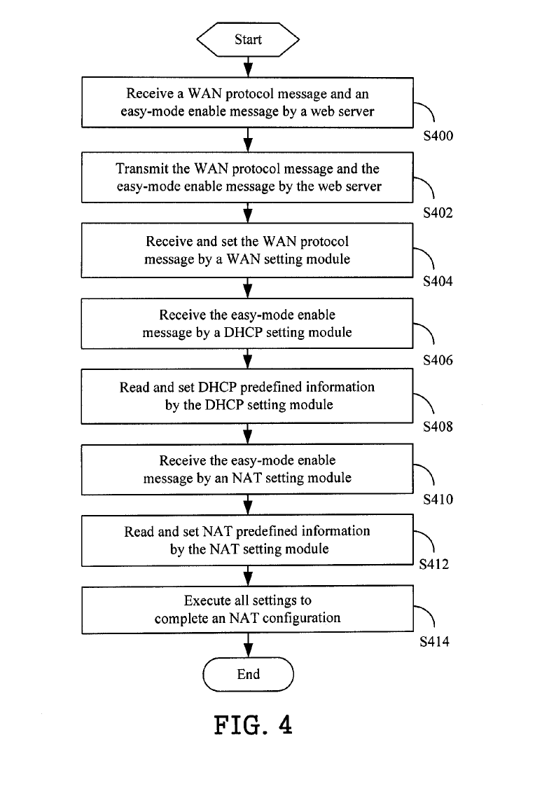

FIG. 4 is a detailed flowchart of the NAT configuration method of FIG. 3. In the exemplary embodiment, the network apparatus 10 is configured as an NAT by using an easy mode.

In step S400, the web server 200 receives a WAN protocol message and an easy-mode enable message from the user interface 100. In the exemplary embodiment, the WAN protocol message includes PPPoE information, a username, and a password.

In step S402, the web server 200 transmits the WAN protocol message and the easy-mode enable message. In the exemplary embodiment, the web server 200 transmits the WAN protocol message to the WAN setting module 300, and transmits the easy-mode enable message to the DHCP setting module 400 and the NAT setting module 500.

In step S404, the WAN setting module 300 receives the WAN protocol message from the web server 200, and sets the WAN protocol message. That is, the WAN setting module 300 sets the PPPoE, the username, and the password.

In step S406, the DHCP setting module 400 receives the easy-mode enable message from the web server 200.

In step S408, the DHCP setting module 400 reads and sets DHCP predefined information. In the exemplary embodiment, the DHCP setting module 400 reads the DHCP predefined information according to the easy-mode enable message, and then sets the predefined information, namely setting an LAN IP address, enabling a DHCP server, setting DHCP server start/end addresses, and setting a DHCP lease time.

In step S410, the NAT setting module 500 receives the easy-mode enable message from the web server 200.

In step S412, the NAT setting module 500 reads and sets NAT predefined information. In the exemplary embodiment, the NAT setting module 500 reads the NAT predefined information according to the easy-mode enable message, and then sets the NAT predefined information, namely enabling an NAT and setting the forwarding rule table 610.

In step S414, the system configuration module 700 executes all settings to complete the NAT configuration.

After the NAT configuration of the network apparatus 10, the network apparatus 10 will be rebooted to execute the setting results, thereby acquiring the network service.

Thus, the network apparatus 10 can receive an easy-mode enable message via the input device 110 of the user interface 100, and transmits the easy-mode enable message to the web server 200, thereby easily configuring an NAT.

What is claimed is:

1. A network apparatus, for network address translation (NAT) configuration, comprising:
a web server, for receiving a wide area network (WAN) protocol message and an easy-mode enable message;
a WAN setting module, for setting the WAN protocol message;
a dynamic host configuration protocol (DHCP) setting module, for setting DHCP predefined information according to the easy-mode enable message; and
an NAT setting module, for setting NAT predefined information according to the easy-mode enable message;
wherein, the setting results of the WAN setting module, the DHCP setting module, and the NAT setting module are executed to complete the NAT configuration of the network apparatus.

2. The network apparatus as claimed in claim 1, further comprising a user interface, for receiving the WAN protocol message and the easy-mode enable message, and transmitting the WAN protocol message and the easy-mode enable message to the web server.

3. The network apparatus as claimed in claim 2, wherein the user interface comprises an input device, for receiving the easy-mode enable message.

4. The network apparatus as claimed in claim 1, further comprising a storage module, for storing the DHCP predefined information and the NAT predefined information.

5. The network apparatus as claimed in claim 1, further comprising a system configuration module, for storing and executing the setting results of the WAN setting module, the DHCP setting module, and the NAT setting module.

6. The network apparatus as claimed in claim 1, wherein the WAN protocol message comprises point to point over Ethernet (PPPoE) information.

7. The network apparatus as claimed in claim 1, wherein the DHCP predefined information comprises local area network (LAN) Internet protocol (IP) address information, DHCP server enable information, DHCP server pool start/end address information, and DHCP lease time information.

8. The network apparatus as claimed in claim 7, wherein the DHCP setting module is for setting an LAN IP address, enabling a DHCP server, setting DHCP pool start/end addresses, and setting a DHCP lease time according to the DHCP predefined information.

9. The network apparatus as claimed in claim 7, wherein the DHCP server pool comprises only one IP address.

10. The network apparatus as claimed in claim 9, wherein the NAT predefined information comprises NAT enable information and a forwarding rule table, and the forwarding rule of the forwarding rule table is to forward all user datagram protocol (UDP)/transport control protocol (TCP) packets to the one IP address in the DHCP server pool aside from packets belonging to the network apparatus.

11. The network apparatus as claimed in claim 10, wherein the NAT setting module is for enabling an NAT and setting the forwarding table according to the NAT predefined information.

12. A network address translation (NAT) configuration method, comprising:
receiving a wide area network (WAN) protocol message and an easy-mode enable message;
setting the WAN protocol message;
setting dynamic host configuration protocol (DHCP) predefined information according to the easy-mode enable message;
setting NAT predefined information according to the easy-mode enable message; and
executing all settings to complete the NAT configuration.

13. The NAT configuration method as claimed in claim 12, wherein the DHCP predefined information comprises local area network (LAN) Internet protocol (IP) address information, DHCP server enable information, DHCP server pool start/end address information, and DHCP lease time information.

14. The NAT configuration method as claimed in claim 13, wherein the DHCP server pool comprises only one IP address.

15. The NAT configuration method as claimed in claim 14, wherein the NAT predefined information comprises NAT enable information and a forwarding rule table, and the forwarding rule of the forwarding rule table is to forward all user datagram protocol (UDP)/transport control protocol (TCP) packets to the one IP address in the DHCP server pool aside from packets belonging to a network apparatus.

16. The NAT configuration method as claimed in claim 12, further comprising:
transmitting the WAN protocol message and the easy-mode enable message by a web server.

17. The NAT configuration method as claimed in claim 16, wherein the step of setting DHCP predefined information according to the easy-mode enable message comprises:
receiving the easy-mode enable message from the web server by a DHCP setting module; and
reading and setting the DHCP predefined information by the DHCP setting module.

18. The NAT configuration method as claimed in claim 16, wherein the step of setting NAT predefined information according to the easy-mode enable message comprises:
receiving the easy-mode enable message from the web server by an NAT setting module; and
reading and setting the predefined information by the NAT setting module.
